(19) United States
(12) Patent Application Publication
(10) Pub. No.: US 2005/0017576 A1
(43) Pub. Date: Jan. 27, 2005

(54) Method and device for determining wear of composite material brake disks of a road vehicle

(76) Inventors: Martino Cavanna, Vimercate (IT); Amedeo Visconti, Torino (IT)

Correspondence Address: BIRCH STEWART KOLASCH & BIRCH, PO BOX 747, FALLS CHURCH, VA, 22040-0747, US

(21) Appl. No.: 10/748,218

(22) Filed: Dec. 31, 2003

(30) Foreign Application Priority Data
Jan. 2, 2003 (IT) BO2003A 000003

(51) Int. Cl. B60T 8/34

(52) U.S. Cl. 303/113.1

(57) ABSTRACT

A method and device for determining wear of composite material brake disks of a road vehicle, wherein, the kinetic energy differential of the vehicle induced by deceleration is calculated at each deceleration of the vehicle; an instantaneous value of the energy dissipated by the brake disks during deceleration is determined as a function of the kinetic energy differential of the vehicle; an instantaneous wear contribution of the brake disks during deceleration is determined on the basis of the value of the energy dissipated by the brake disks during deceleration; and a total wear value of the brake disks is updated by adding the instantaneous wear contribution of the brake disks during deceleration to the previous total wear value.

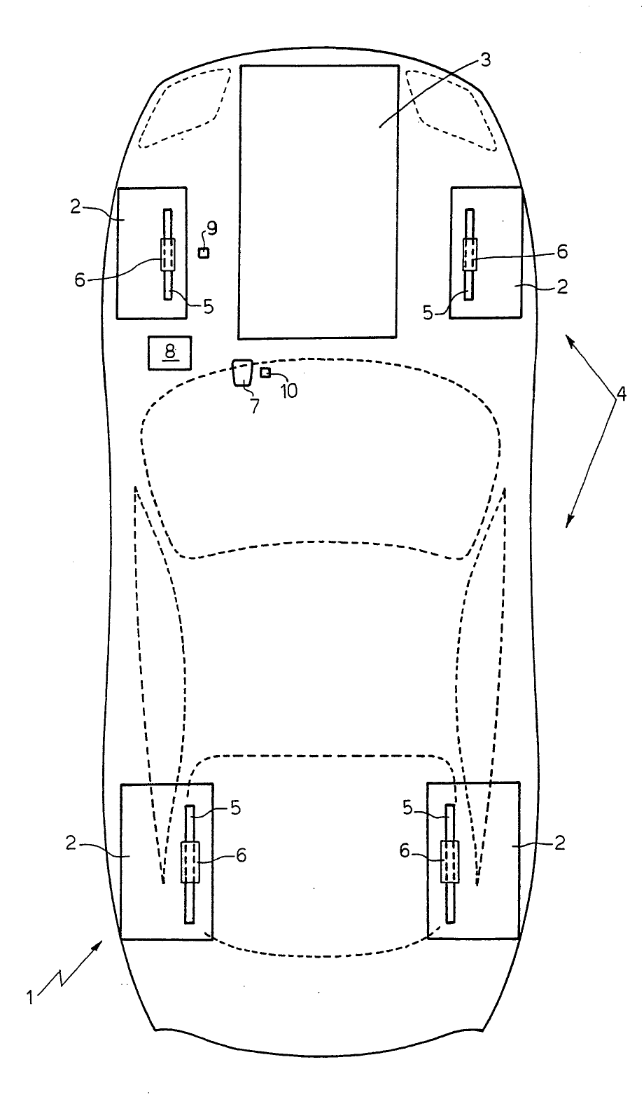

The present invention relates to a method and device for determining wear of composite material brake disks of a road vehicle.

### BACKGROUND OF THE INVENTION

At present, all road racing vehicles (cars and motorcycles) are equipped with metal-disk brakes. On the basis of experience acquired in racing applications, disk brakes with disks made of composite material (in particular, composite ceramic material such as carbon—so-called “CCM disks”) have been proposed, by providing for improved braking performance as compared with metal disks.

In actual use, however, composite material brake disks have been found to deteriorate rapidly, with consequent impairment in mechanical characteristics and fatigue resistance. In particular, over and above a given wear threshold, composite material brake disks fail to ensure safe operation, so that, in a road vehicle equipped with such disks, it is imperative that wear of the disks be determined accurately to inform the driver promptly of the need to replace the disks.

To determine wear of a metal brake disk, it has been proposed, as described for example in U.S. Pat. No. 6,345,700, to use a sensor fitted to and for measuring the thickness of the disk. This solution, however, cannot be applied to composite material brake disks, on account of the sensors not normally having the necessary wear-detecting precision. Moreover, the sensors are relatively expensive, by being called upon to measure wear of a component—the brake disk—rotating at high speed in a dirty environment (further compounded by the dust produced in use by composite material brake disks).

### SUMMARY OF THE INVENTION

It is an object of the present invention to provide a method and device for determining wear of composite material brake disks of a road vehicle, which are cheap and easy to implement and, at the same time, provide for eliminating the aforementioned drawbacks.

According to the present invention, there is provided a method of determining wear of composite material brake disks of a road vehicle, as claimed in claim 1.

According to the present invention, there is provided a device for determining wear of composite material brake disks of a road vehicle, as claimed in claim 16.

### BRIEF DESCRIPTION OF THE DRAWING

A non-limiting embodiment of the present invention will be described by way of example with reference to the accompanying drawing, which shows a schematic view of a vehicle featuring a central control unit operating according to the method of the present invention.

### DETAILED DESCRIPTION OF THE INVENTION

Number 1 in the accompanying drawing indicates a vehicle having four wheels 2 (two front wheels and two rear drive wheels), and comprising a front internal combustion engine 3, and a brake system 4 having four brake disks 5, each of which is located inside a respective wheel 2, and is fitted to a corresponding calliper 6 controlled by a brake pedal 7 in the passenger compartment of vehicle 1.

Brake disks 5 of vehicle 1 are made of composite material, in particular carbon (composite ceramic material), and brake system 4 comprises a central control unit 8 for determining and storing an estimate of the wear of brake disks 5, so as to generate a driver signal when the wear of brake disks 5 exceeds a given safety threshold.

Central control unit 8 is connected to a speed sensor 9, which is fitted to one of front wheels 2 to real-time detect the value v(t) of the travelling speed of the vehicle, and transmit value v(t) to a speedometer on the instrument panel (not shown in detail) of vehicle 1. Central control unit 8 is also connected to a brake sensor 10, which is fitted to brake pedal 7 to determine operation of brake pedal 7 to command the stop lights (not shown in detail) of vehicle 1. It is important to note that both speed sensor 9 and brake sensor 10 are normally already provided on vehicle 1. Central control unit 8 is therefore cheap and easy to install, by operating with existing signals on vehicle 1.

Central control unit 8 stores a total wear value U of brake disks 5, which is reset whenever brake disks 5 are changed.

In actual use, central control unit 8 constantly monitors the speed v(t) of vehicle 1 with a given control frequency, to determine all the decelerations of vehicle 1, i.e. all the situations in which the speed v(t) of vehicle 1 falls from an initial value V1 to a final value V2. At each deceleration of vehicle 1 brought about by actual operation of brake system 4 (as determined by brake sensor 10), central control unit 8 determines an instantaneous wear contribution u of brake disks 5 during deceleration, and updates the total wear value U of brake disks 5 by adding the instantaneous wear contribution u of brake disks 5 during deceleration to the previous total wear value U. The central control unit therefore ignores any deceleration of vehicle 1 not brought about by actual operation of brake system 4, but by friction on vehicle 1 (mainly engine braking, tyre-road friction, and drag).

The total wear value U of brake disks 5 preferably comprises a total wear value Ua of the front brake disks 5, and a total wear value Up of the rear brake disks 5; and the instantaneous wear contribution u of brake disks 5 during deceleration is divided between the two total values Ua and Up as a function of a constant distribution ratio, or a variable distribution ratio (typically calculated at each deceleration as a function of the initial and final speed values V1 and V2 of the deceleration).

To determine the actual value of the instantaneous wear contribution u of brake disks 5 during deceleration brought about by actual operation of brake system 4, central control unit 8 calculates the kinetic energy differential DEk of vehicle 1 induced by deceleration; determines, as a function of the kinetic energy differential DEk of vehicle 1, an instantaneous value Ed of the energy dissipated by brake disks 5 during deceleration; and determines the value of the instantaneous wear contribution u of brake disks 5 during deceleration on the basis of the value Ed of the energy dissipated by brake disks 5 during deceleration. The kinetic energy differential DEk of vehicle 1 induced by deceleration is calculated according to the following equation:
DEk=0.5*M*(V1\hat{ }2−V2\hat{ }2)
where V1 is the initial speed of vehicle 1, V2 is the final speed of vehicle 1 (lower than speed V1), and M is the mass of vehicle 1.

The instantaneous value Ed of the energy dissipated by brake disks 5 during deceleration is typically assumed equal to the kinetic energy differential DEk of vehicle 1. The instantaneous wear contribution u of brake disks 5 during deceleration is determined by multiplying the value Ed of the energy dissipated by brake disks 5 during deceleration by a multiplication constant K ranging between 0 and 1; and the value of constant K is calculated experimentally by means of road and/or track tests.

In an alternative embodiment, at each deceleration, an energy contribution caused by the braking action of friction on vehicle 1 is determined; and the instantaneous value Ed of the energy dissipated by brake disks 5 during deceleration is assumed equal to the difference between kinetic energy differential DEk and the energy contribution caused by the braking action of friction on vehicle 1. By way of example, the energy contribution caused by the braking action of friction on vehicle 1 may be determined as a function of the speed of vehicle 1, since friction due to drag substantially depends on speed, and as a function of engine speed, since engine braking substantially depends on the speed of the engine.

Wear of brake disks 5 has been found to depend both on the energy Ed dissipated by brake disks 5, and on the operating temperature of brake disks 5, i.e. on the way in which energy is dissipated. In other words, the same amount of dissipated energy Ed produces a different amount of wear on the braking area, depending on whether it is dissipated during extreme (typically on-track) use of vehicle 1, in which brake disks 5 reach high temperatures (of over 400/500° C.), or during normal use (typically on public highways). More specifically, the same amount of dissipated energy Ed produces much greater wear of the braking area during extreme, as opposed to normal, use of vehicle 1.

For these reasons, in a preferred embodiment, constant K may assume two different values corresponding respectively to normal and extreme use of vehicle 1. To distinguish between the type of use of vehicle 1, a braking mode assessment is made, and the instantaneous wear contribution u of brake disks 5 during deceleration is determined on the basis of the value Ed of the energy dissipated by brake disks 5 during deceleration, and on the basis of the braking mode assessment, which is obviously directly related to the temperature of brake disks 5 during deceleration.

The braking mode assessment is made on the basis of a mean value of kinetic energy differential DEk within a given time interval, which typically ranges between 0.1 and 5 seconds and may cover a number of successive decelerations brought about by a number of successive operations of brake system 4. If the mean value of kinetic energy differential DEk exceeds a given threshold, this means vehicle 1 is undergoing a series of sharp, repeated decelerations, i.e. is being used in extreme conditions, and constant K assumes a higher value. Conversely, if the mean value of kinetic energy differential DEk is below the given threshold, this means vehicle 1 is not undergoing a series of sharp, repeated decelerations, i.e. is being used in normal conditions, and constant K assumes a lower value.

In alternative embodiments, constant K may assume one value, regardless of how vehicle 1 is used, or may assume more than two values as a function of the braking mode assessment, and in particular as a function of the mean value of kinetic energy differential DEk.

Tests confirm the ability of central control unit 8, as described above, to determine the total wear value U of brake disks 5 extremely accurately, thus enabling a prompt, accurate driver warning signal indicating the need to change brake disks 5.

1) A method of determining wear of composite material brake disks (5) of a road vehicle (1); the method comprising:
calculating, at each deceleration of the vehicle (1), the kinetic energy differential (DEk) of the vehicle (1) induced by deceleration;
determining, as a function of the kinetic energy differential (DEk) of the vehicle (1), an instantaneous value (Ed) of the energy dissipated by the brake disks (5) during deceleration;
determining, on the basis of the value (Ed) of the energy dissipated by the brake disks (5) during deceleration, an instantaneous wear contribution (u) of the brake disks (5) during deceleration; and
updating a total wear value (U) of the brake disks (5) by adding the instantaneous wear contribution (u) of the brake disks (5) during deceleration to the previous total wear value (U).

2) A method as claimed in claim 1, wherein, upon deceleration of the vehicle (1), a corresponding instantaneous value (Ed) of the energy dissipated by the brake disks (5) during deceleration is only determined if the braking action of the brake system (4) of the vehicle (1) is actually used during deceleration.

3) A method as claimed in claim 1, wherein, at each deceleration, an energy contribution caused by the braking action of friction on the vehicle (1) is determined; the energy contribution caused by the braking action of friction on the vehicle (1) being taken into account to determine the instantaneous value (Ed) of the energy dissipated by the brake disks (5) during deceleration as a function of the kinetic energy differential (DEk) of the vehicle (1).

4) A method as claimed in claim 1, wherein, at each deceleration, the temperature of the brake disks (5) during deceleration is determined; the instantaneous wear contribution (u) of the brake disks (5) during deceleration being determined on the basis of the value (Ed) of the energy dissipated by the brake disks (5) during deceleration, and on the basis of the determined temperature of the brake disks (5) during deceleration.

5) A method as claimed in claim 4, wherein a mean value of the kinetic energy differential (DEk) of the vehicle (1) within a given time interval is determined; the temperature of the brake disks (5) during deceleration being determined as a function of the mean value of the kinetic energy differential (DEk).

6) A method as claimed in claim 1, wherein a braking mode assessment is made at each deceleration; the instantaneous wear contribution (u) of the brake disks (5) during deceleration being determined on the basis of the value (Ed) of the energy dissipated by the brake disks (5) during deceleration, and on the basis of the braking mode assessment.

7) A method as claimed in claim 6, wherein a mean value of the kinetic energy differential (DEk) of the vehicle (1) within a given time interval is determined; the braking mode assessment being determined as a function of the mean value of the kinetic energy differential (DEk).

8) A method as claimed in claim 1, wherein the instantaneous value (Ed) of the energy dissipated by the brake disks (5) during deceleration is assumed equal to the kinetic energy differential (DEk) of the vehicle (1); the instantaneous wear contribution (u) of the brake disks (5) during deceleration being determined by multiplying the value (Ed) of the energy dissipated by the brake disks (5) during deceleration by a multiplication constant (K) ranging between (0) and (1).

9) A method as claimed in claim 8, wherein a mean value of the kinetic energy differential (DEk) of the vehicle (1) within a given time interval is determined; the multiplication constant (K) assuming different values as a function of the mean value of the kinetic energy differential (DEk).

10) A method as claimed in claim 8, wherein the multiplication constant (K) may assume two different values corresponding respectively to normal use of the vehicle (1) and extreme use of the vehicle (1).

11) A method as claimed in claim 9, wherein the time interval in which to determine the mean value of the kinetic energy differential (DEk) of the vehicle (1) ranges between 0.1 and 5 seconds.

12) A method as claimed in claim 1, wherein the total wear value (U) of the brake disks (5) is divided between the front brake disks (5) and the rear brake disks (5) as a function of a constant distribution ratio.

13) A method as claimed in claim 1, wherein the total wear value (U) of the brake disks (5) comprises a total wear value (Ua) of the front brake disks (5), and a total wear value (Up) of the rear brake disks (5); the instantaneous wear contribution (u) of the brake disks (5) during deceleration being divided between the two total values (Ua, Up) as a function of a variable distribution ratio.

14) A method as claimed in claim 13, wherein the distribution ratio is calculated at each deceleration as a function of the initial and final speed values (V1, V2) of the deceleration.

15) A method as claimed in claim 1, wherein a signal is generated when the total wear value (U) of the brake disks (5) exceeds a given threshold.

16) A device for determining wear of composite material brake disks (5) of a road vehicle (1), the device implementing the method as claimed in claim 1.
